(19) United States
(12) Patent Application Publication
(10) Pub. No.: US 2026/0109057 A1
(43) Pub. Date: Apr. 23, 2026

(54) ROBOTIC ARM FOR ROBOT

(71) Applicant: Suzhou Xinghaitu Dynamics Technology Co., Ltd., Suzhou (CN)

(72) Inventors: Zeyi YANG, Suzhou (CN); Yao WU, Suzhou (CN); Xinqiao CHEN, Suzhou (CN)

(21) Appl. No.: 19/365,311

(22) Filed: Oct. 22, 2025

(30) Foreign Application Priority Data
Oct. 23, 2024 (CN) 202422564769.8

(51) Int. Cl. B25J 18/00; B25J 9/00; B25J 9/10; B25J 9/12

(52) U.S. Cl. CPC B25J 18/00; B25J 9/0009; B25J 9/108; B25J 9/126

(57) ABSTRACT

A robotic arm for the robot includes a robotic arm base, a robotic arm control board, a first joint mechanism, a second joint mechanism, a robotic upper arm structure, a third joint mechanism, a fourth joint mechanism, a robotic forearm structure, a fifth joint mechanism, and a sixth joint mechanism. The robotic arm control board is disposed within the robotic arm base, the robotic upper arm structure is connected to the robotic arm base through the second joint mechanism and the first joint mechanism, the robotic forearm structure is connected to the robotic upper arm structure through the fourth joint mechanism and the third joint mechanism, the fifth joint mechanism and the sixth joint mechanism are disposed at a tail end of the robotic forearm structure, and the robotic forearm structure is connected to a gripper structure of the robot through the fifth joint mechanism and the sixth joint mechanism.

### CROSS-REFERENCE TO RELATED APPLICATIONS

This application claims priority to Chinese Patent Application No. 202422564769.8 filed Oct. 23, 2024, the disclosure of which is incorporated herein by reference in its entirety.

### TECHNICAL FIELD

The present disclosure relates to the technical field of robots, and in particular, to a robotic arm for a robot.

### BACKGROUND

With the advancement of computer technology, microelectronic technology, and network technology, robotic technology has also developed rapidly. At present, robots are not only applied in the industrial field but also in fields closely related to daily life, such as service robots, educational robots, and entertainment robots. These robots are provided with structures such as heads, torsos, robotic arms, and grippers, and the production and application of these robots have brought convenience and enjoyment to human life. In the related art, a tail end of a robotic arm is relatively heavy, thereby resulting in a relatively small payload at the tail end of the robotic arm, so the robotic arm can only be connected to a relatively light gripper structure. In addition, external wirings are adopted for most robotic arms, making the overall appearance of robots more cluttered.

### SUMMARY

According to an embodiment of the present disclosure, a robotic arm for a robot is provided. The robotic arm for the robot includes a robotic arm base, a robotic arm control board, a first joint mechanism, a second joint mechanism, a robotic upper arm structure, a third joint mechanism, a fourth joint mechanism, a robotic forearm structure, a fifth joint mechanism, and a sixth joint mechanism.

The robotic arm control board is disposed within the robotic arm base, the robotic arm for the robot is configured to be securely connected to a torso of the robot through the robotic arm base, the robotic upper arm structure is connected to the robotic arm base through the second joint mechanism and the first joint mechanism, the robotic forearm structure is connected to the robotic upper arm structure through the fourth joint mechanism and the third joint mechanism, the fifth joint mechanism and the sixth joint mechanism are disposed at a tail end of the robotic forearm structure, and the robotic forearm structure is configured to be connected to a gripper structure of the robot through the fifth joint mechanism and the sixth joint mechanism.

The first joint mechanism includes a first joint mechanism includes a first arm motor, the second joint mechanism includes a second arm motor, the first arm motor is securely mounted on the robotic arm base, an output shaft of the first arm motor is securely connected to the second joint mechanism, and an output shaft of the second arm motor is securely connected to the robotic upper arm structure; the first arm motor is configured to drive the robotic arm for the robot to rotate around a central axis paralleled to a central axis of the robotic arm base when the second arm motor operates, the second arm motor is configured to drive the robotic upper arm structure to rotate around a central axis of the output shaft of the second arm motor when the second arm motor operates, and the central axis of the output shaft of the second arm motor is perpendicular to the central axis of the robotic arm base; the third joint mechanism includes a third arm motor, the fourth joint mechanism includes a fourth arm motor, the third arm motor is securely disposed at a tail end of the robotic upper arm structure, an output shaft of the third arm motor is securely connected to the fourth joint mechanism, and an output shaft of the fourth arm motor is securely connected to the robotic forearm structure; the third arm motor is configured to drive the robotic forearm structure to rotate around a central axis of the output shaft of the third arm motor when the third arm motor operates, where the central axis of the output shaft of the third arm motor is parallel to the central axis of the output shaft of the second arm motor, and the fourth arm motor is configured to drive the robotic forearm structure to rotate around a central axis of the output shaft of the fourth arm motor when the fourth arm motor operates, where the central axis of the output shaft of the fourth arm motor is perpendicular to the central axis of the output shaft of the third arm motor; the fifth joint mechanism includes a fifth arm motor, the sixth joint mechanism includes a sixth arm motor, the fifth arm motor is securely disposed at a tail end of the robotic forearm structure, an output shaft of the fifth arm motor is securely connected to the sixth joint mechanism, and an output shaft of the sixth arm motor is securely connected to the gripper structure of the robot; the fifth arm motor is configured to drive the gripper structure of the robot to rotate around a central axis of the output shaft of the fifth arm motor when the fifth arm motor operates, where the central axis of the output shaft of the fifth arm motor is perpendicular to the central axis of the output shaft of the fourth arm motor, and the sixth arm motor is configured to drive the gripper structure of the robot to rotate around a central axis of the output shaft of the sixth arm motor when the sixth arm motor operates, where the central axis of the output shaft of the sixth arm motor is perpendicular to the central axis of the output shaft of the fifth arm motor; the robotic arm control board is electrically connected to the first arm motor, the second arm motor, the third arm motor, the fourth arm motor, the fifth arm motor, and the sixth arm motor.

In some embodiments of the present disclosure, the first joint mechanism further includes a first arm bearing, a first arm bearing seat, a base housing, a first joint output member, and a second joint output member.

The base housing is securely mounted on the robotic arm base, and the first arm motor and the robotic arm control board are disposed within the base housing; the first arm bearing is securely mounted on the first arm motor through the first arm bearing seat; the first joint output member is securely mounted on the output shaft of the first arm motor, a middle portion of the first joint output member is provided with a first joint connecting portion, each of both ends of the first joint connecting portion extends in a respective direction facing away from the first joint output member along a direction perpendicular to the first joint output member, and the first joint connecting portion is provided with a first joint mounting hole penetrating through two opposite end surfaces of the first joint connecting portion; the second joint output member is rotatably connected to an opening end of the base housing facing away from the robotic arm base through the first arm bearing, an end surface of the second joint output member that is located within the base housing is formed with a first joint annular groove, a middle portion of the second joint output member is provided with a second joint mounting hole penetrating through the second joint output member, the second joint mounting hole is disposed corresponding to the first joint mounting hole, the second joint output member is provided with at least one first arm threading hole penetrating through an inside and an outside of the base housing, and an end surface of the second joint output member that is located outside the base housing is securely connected to a second arm motor seat of the second arm motor; one end of the first joint connecting portion facing the first arm motor is inserted into the output shaft of the first arm motor, the other end of the first joint connecting portion facing away from the first arm motor is inserted into the middle portion of the second joint output member, the second joint output member, the first joint output member, and the output shaft of the first arm motor are securely connected through a bolt that sequentially penetrates through the second joint mounting hole and the first joint mounting hole and is securely connected to the output shaft of the first arm motor, a first wiring gap is formed between the second joint output member, and both of the first joint output member and the first arm motor, and a wire partially outside the base housing is electrically connected to the robotic arm control board through the first arm threading hole, the first wiring gap, and a housing gap between the first arm motor and the base housing; an outer surface of the first arm bearing seat is provided with a first joint limiting block, the second joint output member is provided with a second joint limiting block corresponding to the first joint limiting block, and the first joint limiting block is configured to block the second joint limiting block to limit a rotation of the output shaft of the first arm motor; the first arm bearing seat is provided with a first arm threading block penetrating an inside and an outside of the first arm bearing seat; the base housing is provided with at least one data interface electrically connected to the robotic arm control board.

In some embodiments of the present disclosure, the second joint mechanism further includes a second arm bearing, a second arm motor seat, and a second arm bearing seat.

The second arm motor is disposed within the second arm motor seat, the second arm bearing is disposed within the second arm bearing seat, the second arm motor seat and the second arm bearing seat are engaged and secured, both the second arm motor seat and the second arm bearing seat are securely connected to the output shaft of the first arm motor, the output shaft of the second arm motor is securely connected to the robotic upper arm structure, and the robotic upper arm structure is rotatably connected to the second arm bearing seat through the second arm bearing.

In some embodiments of the present disclosure, the robotic upper arm structure includes an upper arm connecting frame, an upper arm upper frame, an upper arm lower frame, and an upper arm housing.

The upper arm connecting frame includes an upper arm output portion and an upper arm auxiliary portion; one end of the upper arm output portion is securely connected to the output shaft of the second arm motor, and one end of the upper arm auxiliary portion is rotatably connected to the second arm bearing seat through the second arm bearing; the other end of the upper arm output portion and the other end of the upper arm auxiliary portion are provided with upper arm mounting plates respectively, and each upper arm mounting plate of the upper arm mounting plates is a rectangular plate structure; the upper arm upper frame and the upper arm lower frame are engaged, are securely connected by bolts, and are symmetrically disposed, two opposite side surfaces of the upper arm upper frame and two opposite side surfaces of the upper arm lower frame are formed with upper arm mounting grooves respectively, each upper arm mounting plate is snap-fitted with respective two upper arm mounting grooves on a same side of the upper arm upper frame and the upper arm lower frame among the upper arm mounting grooves, each upper arm mounting plate is securely connected to the upper arm upper frame and the upper arm lower frame by bolts so that the upper arm connecting frame, the upper arm upper frame, and the upper arm lower frame are securely connected, a second wiring gap is formed between the upper arm upper frame and the upper arm lower frame, and one end of the upper arm upper frame facing away from the upper arm connecting frame and one end of the upper arm lower frame facing away from the upper arm connecting frame are securely connected to the third joint mechanism; the upper arm housing includes an upper arm upper housing and an upper arm lower housing, the upper arm lower housing is securely connected to the upper arm lower frame by bolts, the upper arm upper housing is securely connected to the upper arm connecting frame by bolts, and the upper arm upper housing and the upper arm lower housing are engaged so that the upper arm connecting frame, the upper arm upper frame, and the upper arm lower frame are located within the upper arm housing; an outer surface of the second arm motor seat and an outer surface of the second arm bearing seat are each formed with a first joint limiting groove, the first joint limiting groove is a groove structure configured to allow a preset rotation angle, both the upper arm output portion and the upper arm auxiliary portion are disposed within the first joint limiting groove, and the first joint limiting groove is configured to limit a rotation of the output shaft of the second arm motor.

In some embodiments of the present disclosure, the third joint mechanism further includes a third arm motor seat, a third arm bearing, a third arm bearing seat, and a first joint connecting frame.

The third arm motor is securely mounted within the third arm motor seat, the third arm bearing is mounted within the third arm bearing seat, and the third arm bearing seat and the third arm motor seat are engaged and securely connected; the first joint connecting frame includes a first joint output portion, a first joint auxiliary portion, and a second joint connecting portion, the fourth joint mechanism is disposed on one end surface of the second joint connecting portion, one end of the first joint output portion and one end of the first joint auxiliary portion are securely connected to two opposite side surfaces of the second joint connecting portion by bolts respectively, the other end of the first joint output portion is securely connected to the output shaft of the third arm motor, and the other end of the first joint auxiliary portion is rotatably connected to the third arm bearing seat through the third arm bearing; an outer surface of the third arm motor seat and an outer surface of the third arm bearing seat are formed with second joint limiting grooves respectively, an inner surface of the first joint output portion and an inner surface of the first joint auxiliary portion are provided with third joint limiting blocks respectively, two third joint limiting blocks are in one-to-one correspondence with two second joint limiting grooves, the third joint limiting blocks are disposed within the second joint limiting grooves respectively, and the third joint limiting blocks are configured to move within the second joint limiting grooves to limit a rotation of the output shaft of the third arm motor.

In some embodiments of the present disclosure, the fourth joint mechanism further includes a fourth arm motor seat, a fourth arm bearing, a fifth arm bearing, a fourth arm bearing seat, and a joint output shaft.

The fourth arm motor is securely mounted within the fourth arm motor seat, both the fourth arm bearing and the fifth arm bearing are mounted within the fourth arm bearing seat, the fourth arm bearing seat and the fourth arm motor seat are engaged and securely connected, one end of the joint output shaft is securely connected to the output shaft of the fourth arm motor, and the other end of the joint output shaft is securely connected to the robotic forearm structure through the fourth arm bearing and the fifth arm bearing.

In some embodiments of the present disclosure, the robotic forearm structure includes a first forearm connecting rod, a second forearm connecting rod, a third forearm connecting rod, a forearm housing bracket, and a forearm housing.

Both ends of the second forearm connecting rod are securely connected to one end of the first forearm connecting rod and one end of the third forearm connecting rod respectively, the other end of the first forearm connecting rod is securely connected to the other end of the joint output shaft, and the other end of the third forearm connecting rod is securely connected to a fifth arm motor seat of the fifth arm motor; the output shaft of the fourth arm motor is provided with a fourth joint limiting block, an inner surface of the fourth arm bearing seat is provided with a fifth joint limiting block corresponding to the fourth joint limiting block, and the fifth joint limiting block is configured to block the fourth joint limiting block to limit a rotation of the output shaft of the fourth arm motor; one end of the forearm housing bracket is securely connected to an end surface of the fourth arm bearing seat, the forearm housing is securely connected to the forearm housing bracket, and the forearm housing bracket is securely connected to the fourth arm bearing seat, and the first forearm connecting rod, the second forearm connecting rod, the third forearm connecting rod, and the forearm housing bracket are all located within the forearm housing..

In some embodiments of the present disclosure, the forearm housing includes a forearm upper housing, a forearm lower housing, and a forearm snap-fit housing.

The forearm lower housing is securely connected to the forearm housing bracket by bolts, two opposite ends of an inner surface of the forearm lower housing facing the fifth arm motor are formed with two forearm slots respectively, the forearm snap-fit housing is provided with two forearm snap-fit blocks, the two forearm snap-fit blocks are in one-to-one correspondence with the two forearm slots, the forearm snap-fit blocks are securely snap-fitted within the two forearm slots respectively, and the forearm snap-fit housing is securely connected to one end of the forearm lower housing to form a circular through hole for a connection of the robotic forearm structure and the fifth joint mechanism; one end of the forearm upper housing facing the fourth arm motor seat is provided with two forearm connecting snap-fit portions, an outer surface of the first joint output portion and an outer surface of the first joint auxiliary portion are provided with joint housings respectively, each of the joint housings is formed with an annular snap-fit slot in a circumferential direction of a respective joint housing, each of the two forearm connecting snap-fit portions is snap-fitted with the annular snap-fit slot, the forearm upper housing and the forearm snap-fit housing are snap-fitted and secured, and the forearm upper housing and the forearm lower housing are securely connected by bolts so that the forearm upper housing, the forearm lower housing, and the forearm snap-fit housing jointly form an enclosed forearm inner chamber; the first forearm connecting rod, the second forearm connecting rod, the third forearm connecting rod, the forearm housing bracket, the fourth arm bearing, the fifth arm bearing, the fourth arm bearing seat, and the joint output shaft are all located within the forearm inner chamber.

In some embodiments of the present disclosure, the fifth joint mechanism further includes a fifth arm motor seat, an arm output frame, an arm wire-pressing buckle, and an arm wire-pressing housing.

The fifth arm motor is securely mounted within the fifth arm motor seat; the arm output frame is an L-shaped bracket structure, one end of a vertical portion of the arm output frame facing away from a horizontal portion of the arm output frame is securely connected to the output shaft of the fifth arm motor, and a sixth arm motor seat of the sixth arm motor is securely disposed on the horizontal portion of the arm output frame; a motor seat end surface of the fifth arm motor seat facing the output shaft of the fifth arm motor is provided with a sixth joint limiting block, and the sixth joint limiting block is configured to block the vertical portion of the arm output frame to limit a rotation of the output shaft of the fifth arm motor; the arm wire-pressing buckle is disposed on a motor tail cover of the fifth arm motor seat, and a wire of the sixth arm motor is pressed and limited through the arm wire-pressing buckle, penetrates through the arm wire-pressing buckle, and enters a forearm housing of the robotic forearm structure; the arm wire-pressing housing is securely connected to the motor tail cover of the fifth arm motor seat to cover the arm wire-pressing buckle.

In some embodiments of the present disclosure, the sixth joint mechanism further includes the sixth arm motor seat and a gripper securing seat.

The sixth arm motor is securely mounted within the sixth arm motor seat; the sixth arm motor seat is disposed on an end surface of the horizontal portion of the arm output frame facing the fifth arm motor seat, the output shaft of the sixth arm motor penetrates through the horizontal portion of the arm output frame and is securely connected to the gripper securing seat, and the gripper securing seat is configured for the gripper structure of the robot to be securely mounted on.

Through the arrangement of multiple joint mechanisms together with an upper arm and a forearm, the robotic arm can rotate in multiple degrees of freedom, and the tail end of the robotic arm can be lighter, thereby increasing the payload at the tail end.

### BRIEF DESCRIPTION OF DRAWINGS

To illustrate the technical solutions in embodiments of the present disclosure or the related art more clearly, drawings used in the description of the embodiments or the related art are briefly described below. Apparently, the drawings described below illustrate only part of the embodiments of the present disclosure, and those of ordinary skill in the art may obtain other drawings based on the drawings described below on the premise that no creative work is done.

FIG. 1 is a structural view of a robotic arm for a robot according to an embodiment of the present disclosure.

FIG. 2 is a view of the assembly of a robotic arm base, a first joint mechanism, and a second joint mechanism in a robotic arm for a robot according to an embodiment of the present disclosure.

FIG. 3 is a partially structural view of a first joint mechanism in a robotic arm for a robot according to an embodiment of the present disclosure.

FIG. 4 is a cross-sectional view of a first joint mechanism in a robotic arm for a robot according to an embodiment of the present disclosure.

FIG. 5 is a partial view of the assembly of a first joint output member in a robotic arm for a robot according to an embodiment of the present disclosure.

FIG. 6 is a structural view of a first joint mechanism, a second joint mechanism, and a robotic upper arm structure in a robotic arm for a robot according to an embodiment of the present disclosure.

FIG. 7 is a view of the assembly of an upper arm lower housing in a robotic arm for a robot according to an embodiment of the present disclosure.

FIG. 8 is a view of the assembly of a second joint mechanism, an upper arm upper frame, and an upper arm lower frame in a robotic arm for a robot according to an embodiment of the present disclosure.

FIG. 9 is a view of the assembly of an upper arm upper frame, an upper arm lower frame, and a third joint mechanism in a robotic arm for a robot according to an embodiment of the present disclosure.

FIG. 10 is a view of the assembly of a third joint mechanism, a fourth joint mechanism, a robotic forearm structure, a fifth joint mechanism, and a sixth joint mechanism in a robotic arm for a robot according to an embodiment of the present disclosure.

FIG. 11 is a structural view of a third joint mechanism, a fourth joint mechanism, a robotic forearm structure, a fifth joint mechanism, and a sixth joint mechanism in a robotic arm for a robot according to an embodiment of the present disclosure, where motors, bearings, a forearm upper housing, and a forearm snap-fit housing are not mounted.

FIG. 12 is a structural view of a first joint auxiliary portion in a robotic arm for a robot according to an embodiment of the present disclosure.

FIG. 13 is a partially structural view of a fourth joint mechanism in a robotic arm for a robot according to an embodiment of the present disclosure.

FIG. 14 is a structural view of a fourth arm motor and a fourth arm bearing seat in a robotic arm for a robot according to an embodiment of the present disclosure.

FIG. 15 is a view of the assembly of connecting rods of a robotic forearm structure in a robotic arm for a robot according to an embodiment of the present disclosure.

FIG. 16 is a view of the assembly of a forearm lower housing and a forearm snap-fit housing in a robotic arm for a robot according to an embodiment of the present disclosure.

FIG. 17 is a structural view of a forearm snap-fit housing in a robotic arm for a robot according to an embodiment of the present disclosure.

FIG. 18 is a structural view of a forearm upper housing in a robotic arm for a robot according to an embodiment of the present disclosure.

FIG. 19 is a partial view of the assembly of a sixth joint mechanism and a fifth joint mechanism in a robotic arm for a robot according to an embodiment of the present disclosure.

### DETAILED DESCRIPTION

The technical solutions in embodiments of the present disclosure are described clearly and completely in conjunction with the drawings in the embodiments of the present disclosure. Apparently, the embodiments described hereinafter are part, not all, of embodiments of the present disclosure. Based on the embodiments of the present disclosure, all other embodiments obtained by those of ordinary skill in the art are within the scope of the present disclosure on the premise that no creative work is done.

It is to be noted that terms "including", "having", and any other variations in the embodiments of the present disclosure and the drawings are intended to encompass a non-exclusive inclusion. For example, a component includes a series of structures, but is not limited to the structures listed. Optionally, the component may further include structures not listed or other parts inherent to these structures.

Embodiments of the present disclosure provide a robotic arm for a robot. Detailed descriptions are provided below.

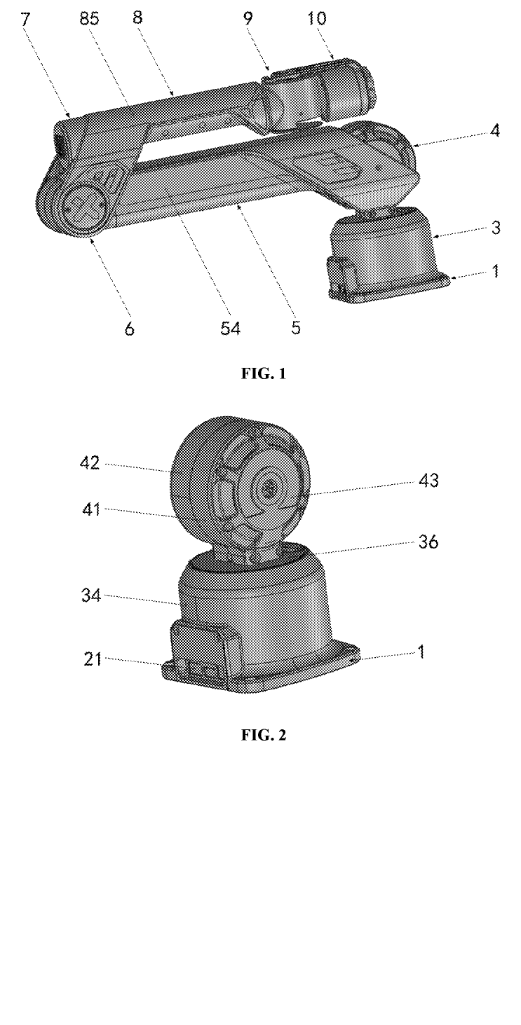

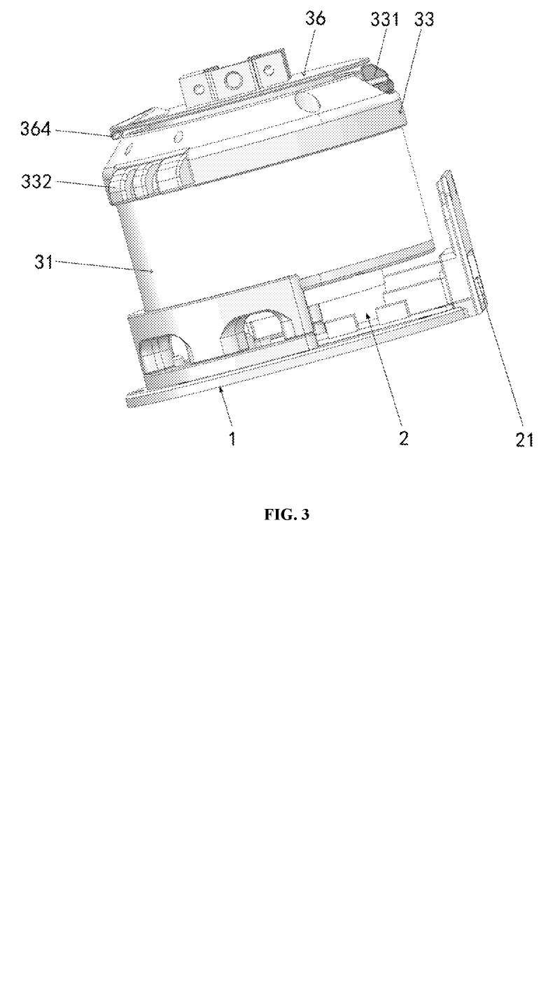

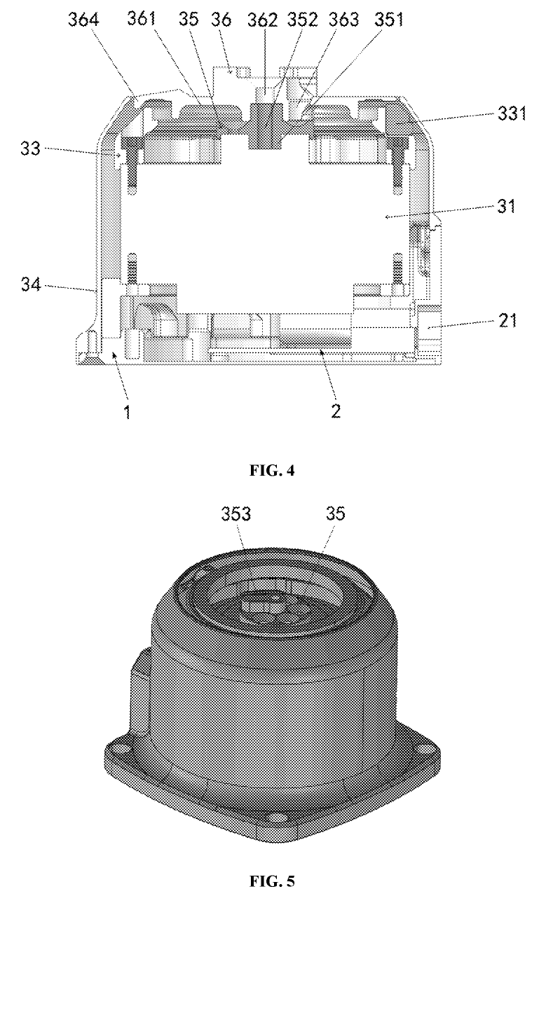

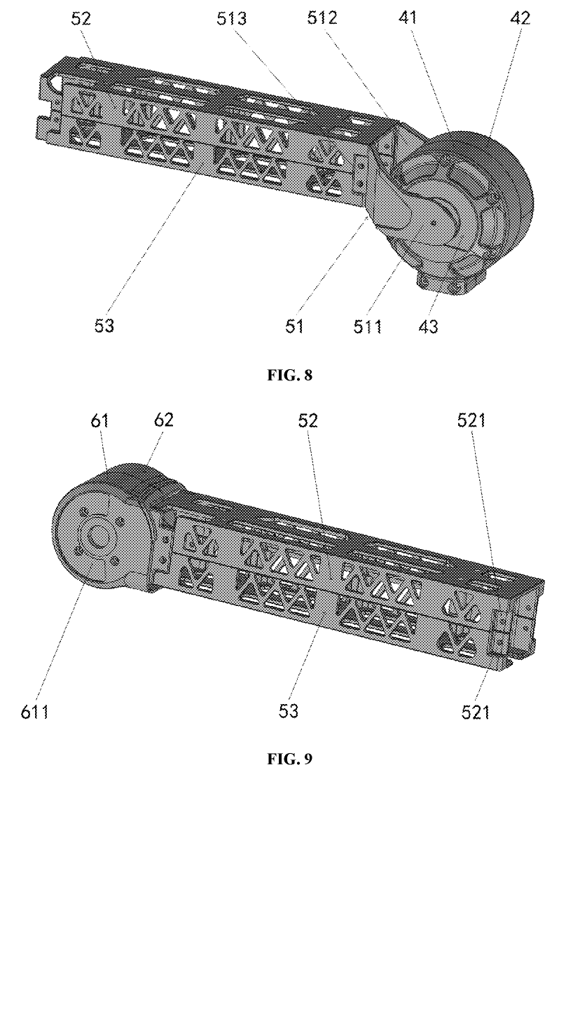

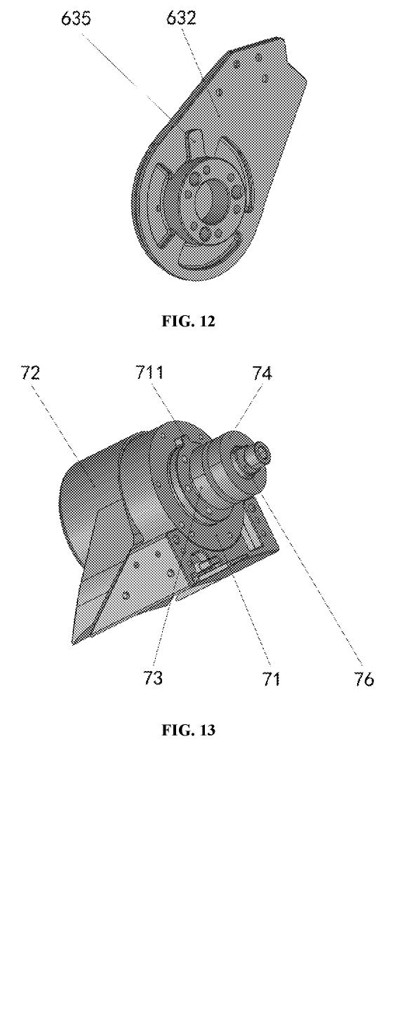

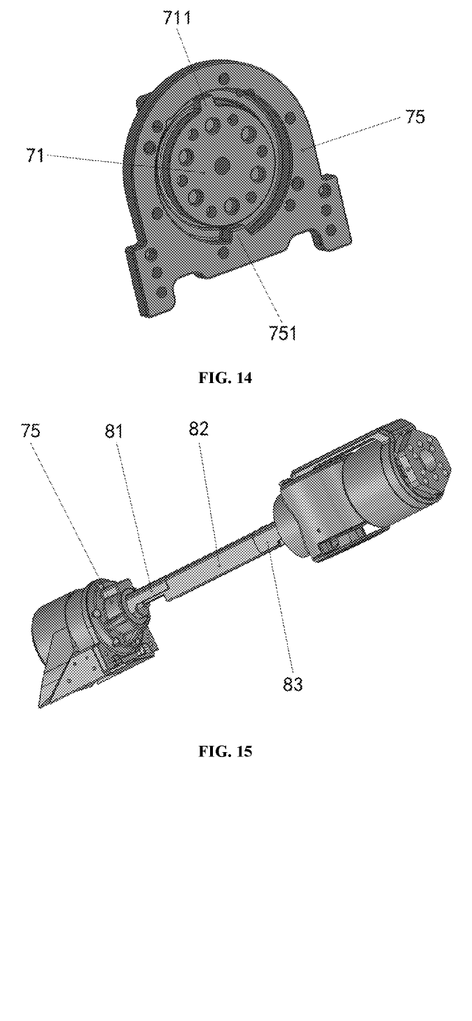

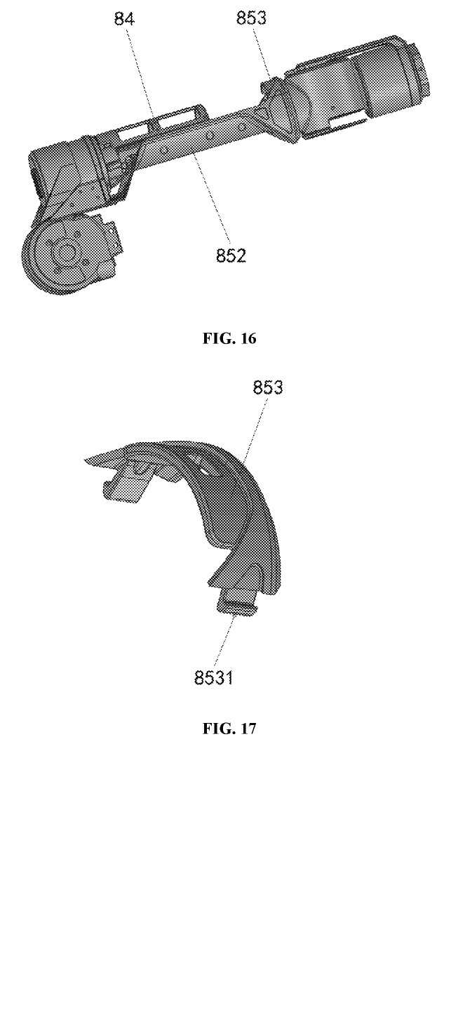

FIGS. 1 to 19 illustrate a robotic arm for a robot according to embodiments of the present disclosure. As shown in FIGS. 1 to 19, the robotic arm for the robot includes a robotic arm base 1, a robotic arm control board 2, a first joint mechanism 3, a second joint mechanism 4, a robotic upper arm structure 5, a third joint mechanism 6, a fourth joint mechanism 7, a robotic forearm structure 8, a fifth joint mechanism 9, and a sixth joint mechanism 10. Specifically, the robotic arm control board 2 is disposed within the robotic arm base 1, the robotic arm for the robot is securely connected to a torso of the robot through the robotic arm base 1, the robotic upper arm structure 5 is connected to the robotic arm base 1 through the second joint mechanism 4 and the first joint mechanism 3, the robotic forearm structure 8 is connected to the robotic upper arm structure 5 through the fourth joint mechanism 7 and the third joint mechanism 6, the fifth joint mechanism 9 and the sixth joint mechanism 10 are disposed at a tail end of the robotic forearm structure 8, and the robotic forearm structure 8 is connected to a gripper structure of the robot through the fifth joint mechanism 9 and the sixth joint mechanism 10. Moreover, the first joint mechanism 3 includes a first arm motor 31, and the second joint mechanism 4 includes a second arm motor. The first arm motor 31 is securely mounted on the robotic arm base 1, an output shaft of the first arm motor 31 is securely connected to the second joint mechanism 4, and an output shaft of the second arm motor is securely connected to the robotic upper arm structure 5. The first arm motor 31 drives the robotic arm for the robot to rotate around a central axis paralleled to a central axis of the robotic arm base 1 when operating, the second arm motor drives the robotic upper arm structure 5 to rotate around a central axis of the output shaft of the second arm motor when operating, and the central axis of the output shaft of the second arm motor is perpendicular to the central axis of the robotic arm base 1. The third joint mechanism 6 includes a third arm motor, and the fourth joint mechanism 7 includes a fourth arm motor 71. The third arm motor is securely disposed at a tail end of the robotic upper arm structure 5, an output shaft of the third arm motor is securely connected to the fourth joint mechanism 7, and an output shaft of the fourth arm motor 71 is securely connected to the robotic forearm structure 8. The third arm motor drives the robotic forearm structure 8 to rotate around a central axis of the output shaft of the third arm motor when operating, where the central axis of the output shaft of the third arm motor is parallel to the central axis of the output shaft of the second arm motor, and the fourth arm motor 71 drives the robotic forearm structure 8 to rotate around a central axis of the output shaft of the fourth arm motor 71 when operating, where the central axis of the output shaft of the fourth arm motor 71 is perpendicular to the central axis of the output shaft of the third arm motor. In addition, the fifth joint mechanism 9 includes a fifth arm motor, and the sixth joint mechanism 10 includes a sixth arm motor. The fifth arm motor is securely disposed at a tail end of the robotic forearm structure 8, an output shaft of the fifth arm motor is securely connected to the sixth joint mechanism 10, and an output shaft of the sixth arm motor is securely connected to the gripper structure of the robot. The fifth arm motor drives the gripper structure of the robot to rotate around a central axis of the output shaft of the fifth arm motor when operating, where the central axis of the output shaft of the fifth arm motor is perpendicular to the central axis of the output shaft of the fourth arm motor 71, and the sixth arm motor drives the gripper structure of the robot to rotate around a central axis of the output shaft of the sixth arm motor when operating, where the central axis of the output shaft of the sixth arm motor is perpendicular to the central axis of the output shaft of the fifth arm motor. In addition, the robotic arm control board 2 is electrically connected to the first arm motor 31, the second arm motor, the third arm motor, the fourth arm motor 71, the fifth arm motor, and the sixth arm motor, for controlling the movements of the robotic arm for the robot. It is to be noted that, in the embodiments of the present disclosure, when the robotic arm for the robot is extended to the maximum distance, that is, when the robotic upper arm structure 5, the robotic forearm structure 8, and the first joint mechanism 3 extend along the same direction, the central axis of the robotic arm base 1, the central axis of the output shaft of the fourth arm motor 71, and the central axis of the output shaft of the sixth arm motor are aligned on the same straight line.

In some embodiments, the first arm motor 31 drives the robotic arm for the robot to rotate around a central axis that is paralleled to a central axis of the robotic arm base 1 and perpendicular to an installation plane, when the first arm motor 31 operates. The installation plane may be a surface of the ground.

In some embodiments, the second arm motor drives the robotic upper arm structure 5 to rotate around a central axis of the output shaft of the second arm motor when operating. The central axis of the output shaft of the second arm motor is perpendicular to the central axis of the robotic arm base, and is paralleled to an installation plane. The installation plane may be a surface of the ground.

In some embodiments, as shown in FIGS. 2 to 5, the first joint mechanism 3 further includes a first arm bearing, a first arm bearing seat 33, a base housing 34, a first joint output member 35, and a second joint output member 36. The base housing 34 is securely mounted on the robotic arm base 1. The base housing 34 and the robotic arm base 1 jointly form a cavity structure configured to accommodate the first arm motor 31, the first arm bearing, the first arm bearing seat 33, and the robotic arm control board 2. The first arm motor 31 is securely mounted on the robotic arm base 1 through a motor mounting bracket, and the robotic arm control board 2 is disposed between the robotic arm base 1 and the motor mounting bracket. Moreover, the first arm bearing is securely mounted on the first arm motor 31 through the first arm bearing seat 33. To achieve the connection and the torque transmission between the first joint mechanism 3 and the second joint mechanism 4, the second joint mechanism 4 is connected to the output shaft of the first arm motor 31 through the first joint output member 35 and the second joint output member 36. Specifically, the first joint output member 35 is securely mounted on the output shaft of the first arm motor 31, a middle portion of the first joint output member 35 is provided with a first joint connecting portion 351, each of both ends of the first joint connecting portion 351 extends in a respective direction facing away from the first joint output member 35 along a direction perpendicular to the first joint output member 35, and the first joint connecting portion 351 is provided with a first joint mounting hole 352 penetrating through two opposite end surfaces of the first joint connecting portion 351. The second joint output member 36 is rotatably connected to an opening end of the base housing 34 facing away from the robotic arm base 1 through the first arm bearing to seal the cavity jointly formed by the base housing 34 and the robotic arm base 1. Moreover, a middle portion of the second joint output member 36 is provided with a second joint mounting hole 362 penetrating through the second joint output member 36, and the second joint mounting hole 362 is disposed corresponding to the first joint mounting hole 352. One end of the first joint connecting portion 351 facing the first arm motor 31 is inserted into the output shaft of the first arm motor 31, the other end of the first joint connecting portion 351 facing away from the first arm motor 31 is inserted into the middle portion of the second joint output member 36, the second joint output member 36, the first joint output member 35, and the output shaft of the first arm motor 31 are securely connected through a bolt that sequentially penetrates through the second joint mounting hole 362 and the first joint mounting hole 352 and is securely connected to the output shaft of the first arm motor 31. Moreover, an end surface of the second joint output member 36 that is located outside the base housing 34 is securely connected to a second arm motor seat 41 of the second arm motor. As such, the first joint mechanism 3 can be connected to the second joint mechanism 4. In the specific implementation, an end surface of the first joint output member 35 facing the second joint output member 36 is also provided with a first joint protruding block 353. Correspondingly, an end surface of the second joint output member 36 facing the first joint output member 35 is formed with a first joint groove. The first joint groove is disposed corresponding to the first joint protruding block 353. The first joint protruding block 353 is snap-fitted with the first joint groove so that the positioning connection between the first joint output member 35 and the second joint output member 36 can be achieved, and the contact area between the first joint output member 35 and the second joint output member 36 can be increased, thereby ensuring the stability of the connection between the first joint mechanism 3 and the second joint mechanism 4. In addition, an end surface of the second joint output member 36 that is located within the base housing 34 is formed with a first joint annular groove 361, and the second joint output member 36 is provided with at least one first arm threading hole 363 penetrating through the inside and the outside of the base housing 34. When the first joint output member 35 and the second joint output member 36 are assembled, the formation of the first joint annular groove 361 allows a first wiring gap to be formed between the second joint output member 36, and both of the first joint output member 35 and the first arm motor 31. The first arm bearing seat 33 is provided with a first arm threading block 332 penetrating through the inside and the outside of the first arm bearing seat 33. As such, a wire partially outside the base housing 34 is electrically connected to the robotic arm control board 2 through the first arm threading hole 363, the first wiring gap, the first arm threading block 332, and a housing gap between the first arm motor 31 and the base housing 34. In addition, an outer surface of the first arm bearing seat 33 is provided with a first joint limiting block 331, and the second joint output member 36 is provided with a second joint limiting block 364 corresponding to the first joint limiting block 331. When operating, the first arm motor 31 drives the first joint output member 35 and the second joint output member 36 to rotate. During this process, the first joint limiting block 331 blocks the second joint limiting block 364 to limit the rotation of the output shaft of the first arm motor 31, so as to prevent the wiring within the base housing 34 from becoming entangled and affecting the operation of the first arm motor 31. Further, the base housing 34 is provided with at least one data interface 21 electrically connected to the robotic arm control board 2 so that the robotic arm control board 2 can transmit data through the at least one data interface 21.

In some other embodiments, as shown in FIGS. 1, 2, 4, and 6, the second joint mechanism 4 further includes a second arm bearing, the second arm motor seat 41, and a second arm bearing seat 42. The second arm motor is disposed within the second arm motor seat 41, the second arm bearing is disposed within the second arm bearing seat 42, the second arm motor seat 41 and the second arm bearing seat 42 are engaged and secured, both the second arm motor seat 41 and the second arm bearing seat 42 are securely connected to the output shaft of the first arm motor 31, the output shaft of the second arm motor is securely connected to the robotic upper arm structure 5, and the robotic upper arm structure 5 is rotatably connected to the second arm bearing seat 42 through the second arm bearing, thereby driving the robotic upper arm structure 5 to rotate through the second arm motor.

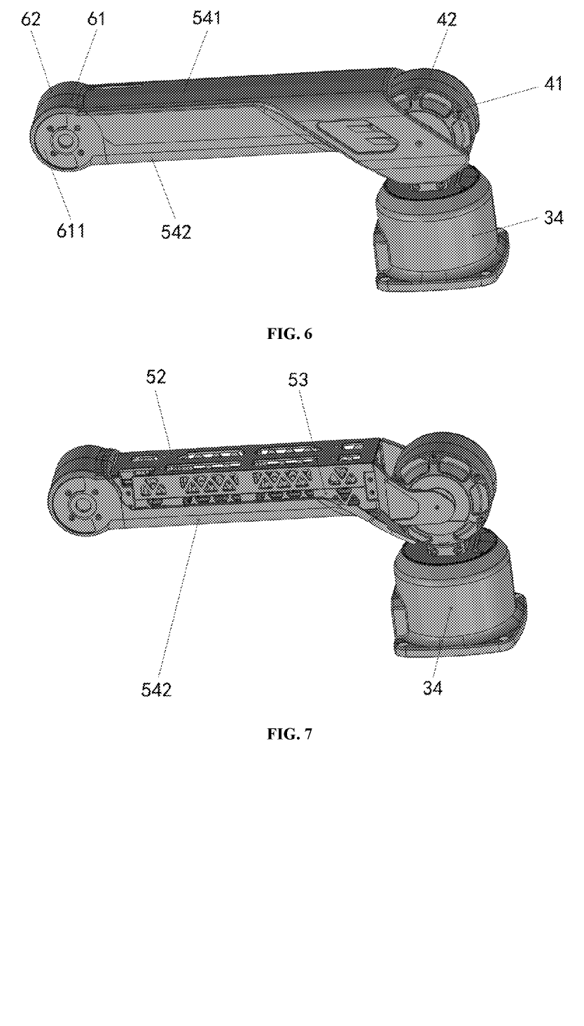

Further, as shown in FIGS. 6 to 9, the robotic upper arm structure 5 includes an upper arm connecting frame 51, an upper arm upper frame 52, an upper arm lower frame 53, and an upper arm housing 54. The upper arm connecting frame 51 includes an upper arm output portion 511 and an upper arm auxiliary portion 512; one end of the upper arm output portion 511 is securely connected to the output shaft of the second arm motor, and one end of the upper arm auxiliary portion 512 is rotatably connected to the second arm bearing seat 42 through the second arm bearing; the other end of the upper arm output portion 511 and the other end of the upper arm auxiliary portion 512 are provided with upper arm mounting plates 513 respectively. As such, the upper arm connecting frame 51 is securely connected to the upper arm upper frame 52 and the upper arm lower frame 53 through two upper arm mounting plates 513. Specifically, each upper arm mounting plate 513 is a rectangular plate structure, two opposite side surfaces of the upper arm upper frame 52 and two opposite side surfaces of the upper arm lower frame 53 are formed with upper arm mounting grooves 521 respectively, and the upper arm upper frame 52 and the upper arm lower frame 53 are symmetrically disposed. When the upper arm upper frame 52 and the upper arm lower frame 53 are engaged and securely connected by bolts, two upper arm mounting grooves 521 on the same side of the upper arm upper frame 52 and the upper arm lower frame 53 jointly form a rectangular groove matching an upper arm mounting plate 513. Each upper arm mounting plate 513 is snap-fitted with respective two upper arm mounting grooves 521 on the same side of the upper arm upper frame 52 and the upper arm lower frame 53, and each upper arm mounting plate 513 is securely connected to the upper arm upper frame 52 and the upper arm lower frame 53 by bolts. As such, the upper arm connecting frame 51, the upper arm upper frame 52, and the upper arm lower frame 53 are securely connected. Moreover, one end of the upper arm upper frame 52 facing away from the upper arm connecting frame 51 and one end of the upper arm lower frame 53 facing away from the upper arm connecting frame 51 are securely connected to the third joint mechanism 6. In addition, through the structural design of the upper arm upper frame 52 and the upper arm lower frame 53 of the robotic upper arm structure 5, a second wiring gap is formed between the upper arm upper frame 52 and the upper arm lower frame 53. A wire of the third joint mechanism 6 is routed through the second wiring gap to the second joint mechanism 4. Moreover, the upper arm housing 54 surrounds the outside of the upper arm upper frame 52 and the outside of the upper arm lower frame 53 so that the robotic upper arm structure 5 has no exposed external wiring, thereby providing a more aesthetic appearance. Further, specifically, the upper arm housing 54 includes an upper arm upper housing 541 and an upper arm lower housing 542, the upper arm lower housing 542 is securely connected to the upper arm lower frame 53 by bolts, the upper arm upper housing 541 is securely connected to the upper arm connecting frame 51 by bolts, and the upper arm upper housing 541 and the upper arm lower housing 542 are engaged so that the upper arm connecting frame 51, the upper arm upper frame 52, and the upper arm lower frame 53 are located within the upper arm housing 54. In addition, an outer surface of the second arm motor seat 41 and an outer surface of the second arm bearing seat 42 are formed with a first joint limiting groove 43, the first joint limiting groove 43 is a groove structure configured to allow a preset rotation angle, and both the upper arm output portion 511 and the upper arm auxiliary portion 512 are disposed within the first joint limiting groove 43. When operating, the second arm motor drives the upper arm output portion 511 and the upper arm auxiliary portion 512 to rotate within the first joint limiting groove 43. As such, the provision of the first joint limiting groove 43 limits the rotation of the output shaft of the second arm motor, thereby avoiding the entanglement of the wire.

In some other embodiments, as shown in FIGS. 1, 7, and FIGS. 9 to 12, the third joint mechanism 6 further includes a third arm motor seat 61, a third arm bearing, a third arm bearing seat 62, and a first joint connecting frame 63. The third arm motor is securely mounted within the third arm motor seat 61, the third arm bearing is mounted within the third arm bearing seat 62, and the third arm bearing seat 62 and the third arm motor seat 61 are engaged and securely connected. The first joint connecting frame 63 includes a first joint output portion 631, a first joint auxiliary portion 632, and a second joint connecting portion 633, the fourth joint mechanism 7 is disposed on one end surface of the second joint connecting portion 633, one end of the first joint output portion 631 and one end of the first joint auxiliary portion 632 are securely connected to two opposite side surfaces of the second joint connecting portion 633 by bolts respectively, the other end of the first joint output portion 631 is securely connected to the output shaft of the third arm motor, and the other end of the first joint auxiliary portion 632 is rotatably connected to the third arm bearing seat 62 through the third arm bearing, thereby driving the fourth joint mechanism 7 to rotate through the third arm motor. Further, an outer surface of the third arm motor seat 61 and an outer surface of the third arm bearing seat 62 are formed with second joint limiting grooves 611 respectively. Correspondingly, an inner surface of the first joint output portion 631 and an inner surface of the first joint auxiliary portion 632 are provided with third joint limiting blocks 635 respectively, two third joint limiting blocks 635 are in one-to-one correspondence with two second joint limiting grooves 611, and the third joint limiting blocks 635 are disposed within the second joint limiting grooves 611 respectively. When operating, the third arm motor drives the first joint output portion 631 and the first joint auxiliary portion 632 to drive, and the third joint limiting blocks 635 move within the second joint limiting grooves 611 to limit a rotation of the output shaft of the third arm motor, thereby avoiding the entanglement of the wire.

Further, as shown in FIGS. 13 to 15, the fourth joint mechanism 7 further includes a fourth arm motor seat 72, a fourth arm bearing 73, a fifth arm bearing 74, a fourth arm bearing seat 75, and a joint output shaft 76. The fourth arm motor 71 is securely mounted within the fourth arm motor seat 72, both the fourth arm bearing 73 and the fifth arm bearing 74 are mounted within the fourth arm bearing seat 75, the fourth arm bearing seat 75 and the fourth arm motor seat 72 are engaged and securely connected, one end of the joint output shaft 76 is securely connected to the output shaft of the fourth arm motor 71, and the other end of the joint output shaft 76 is securely connected to the robotic forearm structure 8 through the fourth arm bearing 73 and the fifth arm bearing 74. In the specific implementation, the fifth arm bearing 74 and the fourth arm bearing seat 75 are configured as back-to-back angular contact bearings. Further, the output shaft of the fourth arm motor 71 is provided with a fourth joint limiting block 711, and an inner surface of the fourth arm bearing seat 75 is provided with a fifth joint limiting block 751 corresponding to the fourth joint limiting block 711. When the fourth arm motor 71 operates, the output shaft of the fourth arm motor 71 rotates, and the fifth joint limiting block 751 is configured to block the fourth joint limiting block 711 to limit the rotation of the output shaft of the fourth arm motor 71, thereby avoiding the entanglement of the wire.

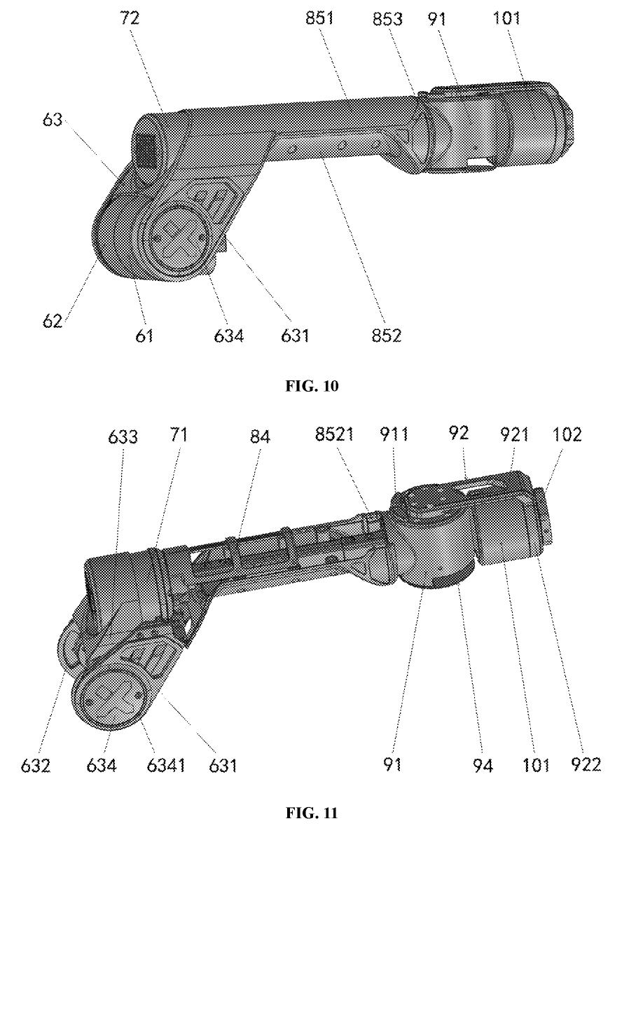

As shown in FIGS. 10 to 18, the robotic forearm structure 8 includes a first forearm connecting rod 81, a second forearm connecting rod 82, a third forearm connecting rod 83, a forearm housing bracket 84, and a forearm housing 85. Both ends of the second forearm connecting rod 82 are securely connected to one end of the first forearm connecting rod 81 and one end of the third forearm connecting rod 83 respectively, the other end of the first forearm connecting rod 81 is securely connected to the other end of the joint output shaft 76, and the other end of the third forearm connecting rod 83 is securely connected to a fifth arm motor seat 91 of the fifth arm motor. As such, torque is transmitted between the fourth joint mechanism 7 and the fifth joint mechanism 9 through the arrangement of the first forearm connecting rod 81, the second forearm connecting rod 82, and the third forearm connecting rod 83. In addition, one end of the forearm housing bracket 84 is securely connected to an end surface of the fourth arm bearing seat 75, the forearm housing 85 is securely connected to the forearm housing bracket 84, the forearm housing bracket 84 is securely connected to the fourth arm bearing seat 75, and the first forearm connecting rod 81, the second forearm connecting rod 82, the third forearm connecting rod 83, and the forearm housing bracket 84 are all located within the forearm housing 85. Further, specifically, the forearm housing 85 includes a forearm upper housing 851, a forearm lower housing 852, and a forearm snap-fit housing 853. The forearm lower housing 852 is securely connected to the forearm housing bracket 84 by bolts, two opposite ends of an inner surface of the forearm lower housing 852 facing the fifth arm motor are formed with forearm slots 8521 respectively, the forearm snap-fit housing 853 is provided with two forearm snap-fit blocks 8531, the two forearm snap-fit blocks 8531 are in one-to-one correspondence with two forearm slots 8521, the forearm snap-fit blocks 8531 are securely snap-fitted within the forearm slots 8521 respectively, and the forearm snap-fit housing 853 is securely connected to one end of the forearm lower housing 852 to form a circular through hole for the connection of the robotic forearm structure 8 and the fifth joint mechanism 9, thereby facilitating the assembly of the forearm housing 85 by separately providing the forearm snap-fit housing 853 and the forearm lower housing 852. In addition, one end of the forearm upper housing 851 facing the fourth arm motor seat 72 is provided with two forearm connecting snap-fit portions 8511, an outer surface of the first joint output portion 631 and an outer surface of the first joint auxiliary portion 632 are provided with joint housings 634 respectively, each of the joint housings 634 is formed with an annular snap-fit slot 6341 in a circumferential direction of a respective joint housing 634, each of the two forearm connecting snap-fit portions 8511 is snap-fitted with the annular snap-fit slot 6341, the forearm upper housing 851 and the forearm snap-fit housing 853 are snap-fitted and secured, and the forearm upper housing 851 and the forearm lower housing 852 are securely connected by bolts to enable the forearm upper housing 851, the forearm lower housing 852, and the forearm snap-fit housing 853 to jointly form an enclosed forearm inner chamber. Moreover, the first forearm connecting rod 81, the second forearm connecting rod 82, the third forearm connecting rod 83, the forearm housing bracket 84, the fourth arm bearing 73, the fifth arm bearing 74, the fourth arm bearing seat 75, and the joint output shaft 76 are all located within the forearm inner chamber.

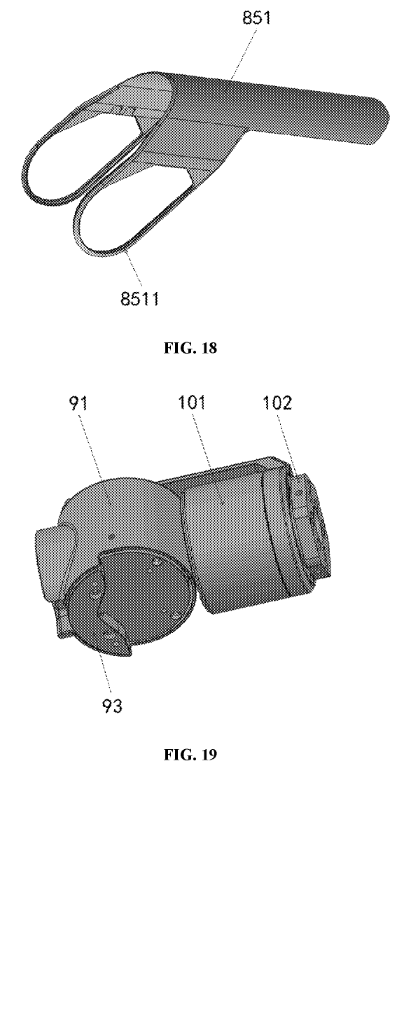

In some other embodiments, as shown in FIGS. 11 and 19, the fifth joint mechanism 9 further includes the fifth arm motor seat 91, an arm output frame 92, an arm wire-pressing buckle 93, and an arm wire-pressing housing 94. The fifth arm motor is securely mounted within the fifth arm motor seat 91. The arm output frame 92 is an L-shaped bracket structure, one end of a vertical portion 921 of the arm output frame 92 facing away from a horizontal portion 922 of the arm output frame 92 is securely connected to the output shaft of the fifth arm motor, and a sixth arm motor seat 101 of the sixth arm motor is securely disposed on the horizontal portion 922 of the arm output frame 92, thereby connecting the fifth joint mechanism 9 to the sixth joint mechanism 10 through the design of the arm output frame 92. Further, a motor seat end surface of the fifth arm motor seat 91 facing the output shaft of the fifth arm motor is provided with a sixth joint limiting block 911. When operating, the fifth arm motor drives the arm output frame 92 to rotate, and the sixth joint limiting block 911 blocks the vertical portion 921 of the arm output frame 92 to limit a rotation of the output shaft of the fifth arm motor, thereby avoiding the entanglement of the wire. Further, the arm wire-pressing buckle 93 is disposed on a motor tail cover of the fifth arm motor seat 91, and a wire of the sixth arm motor is pressed and limited through the arm wire-pressing buckle 93, penetrates through the arm wire-pressing buckle 93, and enters the forearm housing 85 of the robotic forearm structure 8. Moreover, the arm wire-pressing housing 94 is securely connected to the motor tail cover of the fifth arm motor seat 91 to cover the arm wire-pressing buckle 93 and to avoid external wiring so that the robotic arm for the robot can be more beautiful overall.

In addition, as shown in FIG. 19, the sixth joint mechanism 10 further includes the sixth arm motor seat 101 and a gripper securing seat 102. The sixth arm motor is securely mounted within the sixth arm motor seat 101; the sixth arm motor seat 101 is disposed on an end surface of the horizontal portion 922 of the arm output frame 92 facing the fifth arm motor seat 91, and the output shaft of the sixth arm motor penetrates through the horizontal portion 922 of the arm output frame 92 and is securely connected to the gripper securing seat 102, thereby securely mounting the gripper structure of the robot on the gripper securing seat 102.

In conclusion, in the robotic arm for the robot provided in the present disclosure, through the arrangement of multiple joint mechanisms together with an upper arm and a forearm, the robotic arm can rotate in multiple degrees of freedom, and the tail end of the robotic arm can be lighter, thereby increasing the payload at the tail end.

It is to be understood by those of ordinary skill in the art that the drawings are schematic illustrations of one embodiment, and the components shown therein are not necessarily essential to the implementation of the present disclosure. It is to be noted that similar reference numerals and letters represent similar components in the accompanying drawings. Therefore, once a component is defined in one drawing, the component no longer needs to be defined and interpreted in the subsequent drawings.

In the description of the embodiments of the present disclosure, unless otherwise expressly specified and limited, terms like "mounted", "connected to each other", and "connected" are to be construed in a broad sense, for example, as securely connected, detachably connected, or integratedly connected; mechanically connected or electrically connected; directly connected or indirectly connected via an intermediate medium; or internally connected between two elements. For those of ordinary skill in the art, specific meanings of the preceding terms in the present disclosure may be understood based on specific situations. In addition, in the description of the embodiments of the present disclosure, it is to be noted that orientations or position relations indicated by terms such as "center", "upper", "lower", "left", "right", "vertical", "horizontal", "in" and "out" are based on the drawings. These orientations or position relations are intended only to facilitate and simplify the description of the present disclosure and not to indicate or imply that a referred apparatus or element must have such particular orientations or must be configured or operated in such particular orientations. Thus, these orientations or position relations are not to be construed as limiting the present disclosure.

What is claimed is:

1. A robotic arm for a robot, comprising a robotic arm base, a robotic arm control board, a first joint mechanism, a second joint mechanism, a robotic upper arm structure, a third joint mechanism, a fourth joint mechanism, a robotic forearm structure, a fifth joint mechanism, and a sixth joint mechanism,
wherein the robotic arm control board is disposed within the robotic arm base, the robotic arm for the robot is configured to be securely connected to a torso of the robot through the robotic arm base, the robotic upper arm structure is connected to the robotic arm base through the second joint mechanism and the first joint mechanism, the robotic forearm structure is connected to the robotic upper arm structure through the fourth joint mechanism and the third joint mechanism, the fifth joint mechanism and the sixth joint mechanism are disposed at a tail end of the robotic forearm structure, and the robotic forearm structure is configured to be connected to a gripper structure of the robot through the fifth joint mechanism and the sixth joint mechanism; and
wherein the first joint mechanism comprises a first arm motor, the second joint mechanism comprises a second arm motor, the first arm motor is securely mounted on the robotic arm base, an output shaft of the first arm motor is securely connected to the second joint mechanism, and an output shaft of the second arm motor is securely connected to the robotic upper arm structure; the first arm motor is configured to drive the robotic arm for the robot to rotate around a central axis paralleled to a central axis of the robotic arm base when the first arm motor operates, the second arm motor is configured to drive the robotic upper arm structure to rotate around a central axis of the output shaft of the second arm motor when the second arm motor operates, and the central axis of the output shaft of the second arm motor is perpendicular to the central axis of the robotic arm base; the third joint mechanism comprises a third arm motor, the fourth joint mechanism comprises a fourth arm motor, the third arm motor is securely disposed at a tail end of the robotic upper arm structure, an output shaft of the third arm motor is securely connected to the fourth joint mechanism, and an output shaft of the fourth arm motor is securely connected to the robotic forearm structure; the third arm motor is configured to drive the robotic forearm structure to rotate around a central axis of the output shaft of the third arm motor when the third arm motor operates, wherein the central axis of the output shaft of the third arm motor is parallel to the central axis of the output shaft of the second arm motor, and the fourth arm motor is configured to drive the robotic forearm structure to rotate around a central axis of the output shaft of the fourth arm motor when the fourth arm motor operates, wherein the central axis of the output shaft of the fourth arm motor is perpendicular to the central axis of the output shaft of the third arm motor; the fifth joint mechanism comprises a fifth arm motor, the sixth joint mechanism comprises a sixth arm motor, the fifth arm motor is securely disposed at a tail end of the robotic forearm structure, an output shaft of the fifth arm motor is securely connected to the sixth joint mechanism, and an output shaft of the sixth arm motor is securely connected to the gripper structure of the robot; the fifth arm motor is configured to drive the gripper structure of the robot to rotate around a central axis of the output shaft of the fifth arm motor when the fifth arm motor operates, wherein the central axis of the output shaft of the fifth arm motor is perpendicular to the central axis of the output shaft of the fourth arm motor, and the sixth arm motor is configured to drive the gripper structure of the robot to rotate around a central axis of the output shaft of the sixth arm motor when the sixth arm motor operates, wherein the central axis of the output shaft of the sixth arm motor is perpendicular to the central axis of the output shaft of the fifth arm motor; the robotic arm control board is electrically connected to the first arm motor, the second arm motor, the third arm motor, the fourth arm motor, the fifth arm motor, and the sixth arm motor.

2. The robotic arm for the robot according to claim 1, wherein the first joint mechanism further comprises a first arm bearing, a first arm bearing seat, a base housing, a first joint output member, and a second joint output member; and
the base housing is securely mounted on the robotic arm base, and the first arm motor and the robotic arm control board are disposed within the base housing; the first arm bearing is securely mounted on the first arm motor through the first arm bearing seat; the first joint output member is securely mounted on the output shaft of the first arm motor, a middle portion of the first joint output member is provided with a first joint connecting portion, each of both ends of the first joint connecting portion extends in a respective direction facing away from the first joint output member along a direction perpendicular to the first joint output member, and the first joint connecting portion is provided with a first joint mounting hole penetrating through two opposite end surfaces of the first joint connecting portion; the second joint output member is rotatably connected to an opening end of the base housing facing away from the robotic arm base through the first arm bearing, an end surface of the second joint output member that is located within the base housing is formed with a first joint annular groove, a middle portion of the second joint output member is provided with a second joint mounting hole penetrating through the second joint output member, the second joint mounting hole is disposed corresponding to the first joint mounting hole, the second joint output member is provided with at least one first arm threading hole penetrating through an inside and an outside of the base housing, and an end surface of the second joint output member that is located outside the base housing is securely connected to a second arm motor seat of the second arm motor; one end of the first joint connecting portion facing the first arm motor is inserted into the output shaft of the first arm motor, the other end of the first joint connecting portion facing away from the first arm motor is inserted into the middle portion of the second joint output member, the second joint output member, the first joint output member, and the output shaft of the first arm motor are securely connected through a bolt that sequentially penetrates through the second joint mounting hole and the first joint mounting hole and is securely connected to the output shaft of the first arm motor, a first wiring gap is formed between the second joint output member, and both of the first joint output member and the first arm motor, and a wire partially outside the base housing is electrically connected to the robotic arm control board through the first arm threading hole, the first wiring gap, and a housing gap between the first arm motor and the base housing; an outer surface of the first arm bearing seat is provided with a first joint limiting block, the second joint output member is provided with a second joint limiting block corresponding to the first joint limiting block, and the first joint limiting block is configured to block the second joint limiting block to limit a rotation of the output shaft of the first arm motor; the first arm bearing seat is provided with a first arm threading block penetrating an inside and an outside of the first arm bearing seat; the base housing is provided with at least one data interface electrically connected to the robotic arm control board.

3. The robotic arm for the robot according to claim 1, wherein the second joint mechanism further comprises a second arm bearing, a second arm motor seat, and a second arm bearing seat; and
the second arm motor is disposed within the second arm motor seat, the second arm bearing is disposed within the second arm bearing seat, the second arm motor seat and the second arm bearing seat are engaged and secured, both the second arm motor seat and the second arm bearing seat are securely connected to the output shaft of the first arm motor, the output shaft of the second arm motor is securely connected to the robotic upper arm structure, and the robotic upper arm structure is rotatably connected to the second arm bearing seat through the second arm bearing.

4. The robotic arm for the robot according to claim 3, wherein the robotic upper arm structure comprises an upper arm connecting frame, an upper arm upper frame, an upper arm lower frame, and an upper arm housing; and
the upper arm connecting frame comprises an upper arm output portion and an upper arm auxiliary portion; one end of the upper arm output portion is securely connected to the output shaft of the second arm motor, and one end of the upper arm auxiliary portion is rotatably connected to the second arm bearing seat through the second arm bearing; the other end of the upper arm output portion and the other end of the upper arm auxiliary portion are provided with upper arm mounting plates respectively, and each upper arm mounting plate of the upper arm mounting plates is a rectangular plate structure; the upper arm upper frame and the upper arm lower frame are engaged, are securely connected by bolts, and are symmetrically disposed, two opposite side surfaces of the upper arm upper frame and two opposite side surfaces of the upper arm lower frame are formed with upper arm mounting grooves respectively, each upper arm mounting plate is snap-fitted with respective two upper arm mounting grooves on a same side of the upper arm upper frame and the upper arm lower frame among the upper arm mounting grooves, each upper arm mounting plate is securely connected to the upper arm upper frame and the upper arm lower frame by bolts so that the upper arm connecting frame, the upper arm upper frame, and the upper arm lower frame are securely connected, a second wiring gap is formed between the upper arm upper frame and the upper arm lower frame, and one end of the upper arm upper frame facing away from the upper arm connecting frame and one end of the upper arm lower frame facing away from the upper arm connecting frame are securely connected to the third joint mechanism; the upper arm housing comprises an upper arm upper housing and an upper arm lower housing, the upper arm lower housing is securely connected to the upper arm lower frame by bolts, the upper arm upper housing is securely connected to the upper arm connecting frame by bolts, and the upper arm upper housing and the upper arm lower housing are engaged so that the upper arm connecting frame, the upper arm upper frame, and the upper arm lower frame are located within the upper arm housing; an outer surface of the second arm motor seat and an outer surface of the second arm bearing seat are each formed with a first joint limiting groove, the first joint limiting groove is a groove structure configured to allow a preset rotation angle, both the upper arm output portion and the upper arm auxiliary portion are disposed within the first joint limiting groove, and the first joint limiting groove is configured to limit a rotation of the output shaft of the second arm motor.

5. The robotic arm for the robot according to claim 1, wherein the third joint mechanism further comprises a third arm motor seat, a third arm bearing, a third arm bearing seat, and a first joint connecting frame; and
the third arm motor is securely mounted within the third arm motor seat, the third arm bearing is mounted within the third arm bearing seat, and the third arm bearing seat and the third arm motor seat are engaged and securely connected; the first joint connecting frame comprises a first joint output portion, a first joint auxiliary portion, and a second joint connecting portion, the fourth joint mechanism is disposed on one end surface of the second joint connecting portion, one end of the first joint output portion and one end of the first joint auxiliary portion are securely connected to two opposite side surfaces of the second joint connecting portion by bolts respectively, the other end of the first joint output portion is securely connected to the output shaft of the third arm motor, and the other end of the first joint auxiliary portion is rotatably connected to the third arm bearing seat through the third arm bearing; an outer surface of the third arm motor seat and an outer surface of the third arm bearing seat are formed with second joint limiting grooves respectively, an inner surface of the first joint output portion and an inner surface of the first joint auxiliary portion are provided with third joint limiting blocks respectively, two third joint limiting blocks are in one-to-one correspondence with two second joint limiting grooves, the third joint limiting blocks are disposed within the second joint limiting grooves respectively, and the third joint limiting blocks are configured to move within the second joint limiting grooves to limit a rotation of the output shaft of the third arm motor.

6. The robotic arm for the robot according to claim 5, wherein the fourth joint mechanism further comprises a fourth arm motor seat, a fourth arm bearing, a fifth arm bearing, a fourth arm bearing seat, and a joint output shaft; and
the fourth arm motor is securely mounted within the fourth arm motor seat, both the fourth arm bearing and the fifth arm bearing are mounted within the fourth arm bearing seat, the fourth arm bearing seat and the fourth arm motor seat are engaged and securely connected, one end of the joint output shaft is securely connected to the output shaft of the fourth arm motor, and the other end of the joint output shaft is securely connected to the robotic forearm structure through the fourth arm bearing and the fifth arm bearing.

7. The robotic arm for the robot according to claim 6, wherein the robotic forearm structure comprises a first forearm connecting rod, a second forearm connecting rod, a third forearm connecting rod, a forearm housing bracket, and a forearm housing; and
both ends of the second forearm connecting rod are securely connected to one end of the first forearm connecting rod and one end of the third forearm connecting rod respectively, the other end of the first forearm connecting rod is securely connected to the other end of the joint output shaft, and the other end of the third forearm connecting rod is securely connected to a fifth arm motor seat of the fifth arm motor; the output shaft of the fourth arm motor is provided with a fourth joint limiting block, an inner surface of the fourth arm bearing seat is provided with a fifth joint limiting block corresponding to the fourth joint limiting block, and the fifth joint limiting block is configured to block the fourth joint limiting block to limit a rotation of the output shaft of the fourth arm motor; one end of the forearm housing bracket is securely connected to an end surface of the fourth arm bearing seat, the forearm housing is securely connected to the forearm housing bracket, the forearm housing bracket is securely connected to the fourth arm bearing seat, and the first forearm connecting rod, the second forearm connecting rod, the third forearm connecting rod, and the forearm housing bracket are all located within the forearm housing.

8. The robotic arm for the robot according to claim 7, wherein the forearm housing comprises a forearm upper housing, a forearm lower housing, and a forearm snap-fit housing; and
the forearm lower housing is securely connected to the forearm housing bracket by bolts, two opposite ends of an inner surface of the forearm lower housing facing the fifth arm motor are formed with two forearm slots respectively, the forearm snap-fit housing is provided with two forearm snap-fit blocks, the two forearm snap-fit blocks are in one-to-one correspondence with the two forearm slots, the forearm snap-fit blocks are securely snap-fitted within the two forearm slots respectively, and the forearm snap-fit housing is securely connected to one end of the forearm lower housing to form a circular through hole for a connection of the robotic forearm structure and the fifth joint mechanism; one end of the forearm upper housing facing the fourth arm motor seat is provided with two forearm connecting snap-fit portions, an outer surface of the first joint output portion and an outer surface of the first joint auxiliary portion are provided with joint housings respectively, each of the joint housings is formed with an annular snap-fit slot in a circumferential direction of a respective joint housing, each of the two forearm connecting snap-fit portions is snap-fitted with the annular snap-fit slot, the forearm upper housing and the forearm snap-fit housing are snap-fitted and secured, and the forearm upper housing and the forearm lower housing are securely connected by bolts so that the forearm upper housing, the forearm lower housing, and the forearm snap-fit housing jointly form an enclosed forearm inner chamber; the first forearm connecting rod, the second forearm connecting rod, the third forearm connecting rod, the forearm housing bracket, the fourth arm bearing, the fifth arm bearing, the fourth arm bearing seat, and the joint output shaft are all located within the forearm inner chamber.

9. The robotic arm for the robot according to claim 1, wherein the fifth joint mechanism further comprises a fifth arm motor seat, an arm output frame, an arm wire-pressing buckle, and an arm wire-pressing housing;
the fifth arm motor is securely mounted within the fifth arm motor seat; the arm output frame is an L-shaped bracket structure, one end of a vertical portion of the arm output frame facing away from a horizontal portion of the arm output frame is securely connected to the output shaft of the fifth arm motor, and a sixth arm motor seat of the sixth arm motor is securely disposed on the horizontal portion of the arm output frame; a motor seat end surface of the fifth arm motor seat facing the output shaft of the fifth arm motor is provided with a sixth joint limiting block, and the sixth joint limiting block is configured to block the vertical portion of the arm output frame to limit a rotation of the output shaft of the fifth arm motor; the arm wire-pressing buckle is disposed on a motor tail cover of the fifth arm motor seat, and a wire of the sixth arm motor is pressed and limited through the arm wire-pressing buckle, penetrates through the arm wire-pressing buckle, and enters a forearm housing of the robotic forearm structure; the arm wire-pressing housing is securely connected to the motor tail cover of the fifth arm motor seat to cover the arm wire-pressing buckle.

10. The robotic arm for the robot according to claim 9, wherein the sixth joint mechanism further comprises the sixth arm motor seat and a gripper securing seat; and
the sixth arm motor is securely mounted within the sixth arm motor seat; the sixth arm motor seat is disposed on an end surface of the horizontal portion of the arm output frame facing the fifth arm motor seat, the output shaft of the sixth arm motor penetrates through the horizontal portion of the arm output frame and is securely connected to the gripper securing seat, and the gripper securing seat is configured for the gripper structure of the robot to be securely mounted on.
